(19) United States
(12) Patent Application Publication
(10) Pub. No.: US 2023/0376937 A1
(43) Pub. Date: Nov. 23, 2023

(54) ELECTRONIC PAYMENT TERMINAL AND METHOD FOR DETECTING A CORRESPONDING PAYMENT MODE

(71) Applicant: BANKS AND ACQUIRERS INTERNATIONAL HOLDING, Paris (FR)

(72) Inventors: Jean-Eric LEMAIRE, Valence (FR); Olivier BERTHIAUD, Cornas (FR)

(21) Appl. No.: 18/030,533

(22) PCT Filed: Oct. 5, 2021
(86) PCT No.: PCT/EP2021/077377

§ 371 Date: Apr. 6, 2023

(30) Foreign Application Priority Data
Oct. 6, 2020 (FR) 2010200

(51) Int. Cl. G06Q 20/34; G06K 19/07; G06Q 20/20; G06Q 20/32

(52) U.S. Cl. CPC G06Q 20/352; G06K 19/0723; G06Q 20/20; G06Q 20/3263

(57) ABSTRACT

An electronic payment terminal including a processor (CPU), at least one contactless payment antenna referred to as the main antenna (AP), and a first additional antenna (AA1), the antennas being capable of receiving a signal transmitted by an electronic payment card, and features for activating and deactivating the main antenna (AP), selecting the first additional antenna (AA1), comparing, with a first predetermined threshold (S1), a signal level received from the electronic payment card by the first additional antenna (AA 1), the comparison feature delivering a first comparison result and triggering, if the first comparison result is positive, the feature for activating the main antenna (AP) in order to implement a contactless transaction between the electronic payment terminal and the electronic payment card.

### FIELD OF THE INVENTION

The field of the invention is that electronic payment devices, such as electronic payment terminals allowing several payment modes by card: reading of the chip of a card inserted in a slot provided for this purpose, reading of the magnetic stripe of a card sliding in a space provided for this purpose, and contactless reading by approaching the card near the antenna (via the corresponding logo).

### BACKGROUND OF THE INVENTION

The remainder of this document focuses more particularly on describing an existing problem in the field of electronic payment terminals encountered by the inventors of this patent application, concerning the triggering of the various possible payment modes.

Thus, when an electronic payment terminal allows at least two payment modes (for example payment by inserting a card and contactless payment), the functions concerning these various payment modes must be operational regardless of the user's payment choice and without the user having to indicate this choice beforehand. The aim is to “implicitly” trigger the function corresponding to the user's choice. Thus, if the user chooses a payment by inserting their smart card, they approach it near the electronic payment terminal, before inserting it, and the contactless payment function must not be triggered when the user's smart card is approached.

However, contactless payment is managed in particular by the EMV (Europay MasterCard Visa) standard which specifies, in particular, the magnetic field required for the contactless payment function. The current EMV standard requires, for example, that the electric field must be strong enough for the cards to be read more than four centimetres away from the electronic payment terminal, over a large volume.

This constraint may generate interference for the other functions of the electronic payment terminal, which means for example that the antenna must be placed as far as possible away from certain other electronic components.

However, in view of the increasing demand for compact electronic payment terminals, it is becoming difficult to design the architecture of an electronic payment terminal while taking into account these various constraints.

Consequently, for highly compact electronic payment terminal architectures, the various card readers (smart card, swipe card and contactless card) are implemented in the immediate vicinity, as shown for example on figure FIG. 1a. This architecture implies that a card that can be used both for contactless payment and contact payment (by reading the chip or the magnetic stripe) is detected and read by the contactless reader even before it is inserted in the smart card reader or the swipe card reader. Thus, the antenna detection area for contactless payment, shown for example on figure FIG. 1b, is large enough to detect the approach of a card for a payment via either reader (smart card or swipe card). This type of situation may therefore initiate the contactless payment procedure without the user having chosen this payment mode, or generate a transaction error slowing down the procedure for the user.

There is therefore a need for a technique allowing the implicit reading of a contactless card, via the chip or the magnetic stripe, with compact electronic payment terminal and card reader architectures.

### SUMMARY OF THE INVENTION

This technique meets this need by proposing an electronic payment terminal comprising a processor (CPU) and in addition at least one contactless payment antenna, referred to as the main antenna (AP), and a first additional antenna (AA1), the antennas being capable of receiving a signal transmitted by an electronic payment card, the electronic payment terminal also comprising the following means:
means (30) for activating and deactivating the main antenna (AP);
means (20) for selecting the first additional antenna (AA1);
means (40) for comparing, with a first predetermined threshold (S1), a level of signal received from the electronic payment card by the first additional antenna (AA1), the comparison means delivering a first comparison result and triggering, if the first comparison result is positive, the means (30) for activating the main antenna (AP) in order to implement a contactless transaction between the electronic payment terminal and the electronic payment card.

Thus, this technique proposes a novel and inventive solution for the detection of a payment mode when a user approaches their payment card near an electronic payment terminal, while preserving a compact architecture of the electronic payment terminal.

To do this, the electronic payment terminal comprises, in addition to the main antenna dedicated to contactless payment, at least one additional antenna to detect the approach of the card and deduce whether the user wants a contactless payment or wants to insert their card in one of the readers available on the electronic payment terminal (smart card reader or swipe card reader). This detection is implemented in particular by comparing the signal received by the additional antenna with a threshold, and by activating the main antenna if the comparison is positive. Various techniques described below can be used to switch between the additional antenna and the main antenna.

According to a special characteristic, the means (20) for selecting and the means (30) for activating and deactivating the main antenna correspond to a switch receiving at input a signal received by the first additional antenna and a signal received by the main antenna and delivering at output one of the signals received by the first additional antenna and by the main antenna, and the comparison means (40) are implemented in at least one contactless chip (10) receiving at input one of the signals received by the first additional antenna and by the main antenna, i.e. one of the signals delivered at output of the switch.

Thus, the solution is implemented via a switch used to switch from one antenna to the other, and thus to first analyse the signal received on the additional antenna before processing the signal received by the main antenna if a contactless payment is detected. This implementation is simple and inexpensive, since only one contactless chip is required to analyse the signals received respectively by the additional antenna and the main antenna.

According to another alternative embodiment, the electronic payment terminal further comprises a second contactless chip (11) associated with the first additional antenna and the means (20) for selecting and the means (30) for activating and deactivating the main antenna (AP) are implemented in the processor (CPU).

Thus, the solution is implemented via a second contactless chip dedicated to the additional antenna and the CPU of the electronic payment terminal implements the switch between processing the signal received by the additional antenna and processing the signal received by the main antenna.

According to another embodiment, the electronic payment terminal further comprises a second additional antenna (AA2) capable of receiving a signal transmitted by the electronic payment card, and the selection means (20) select the second additional antenna and the comparison means (40) compare a level of signal received from the electronic payment card by the second additional antenna (AA2) with a second predetermined threshold delivering a second comparison result and triggering, if the second comparison result is positive, the means (50) for activating the main antenna (AP) in order to implement a contactless transaction between the electronic payment terminal and the electronic payment card.

This second embodiment implements two additional antennas, advantageously positioned and configured, to improve the detection of the payment mode, such that the contactless payment mode is detected if a signal is detected on the two additional antennas whereas the contactless payment mode is detected if a signal is detected on only one of the two additional antennas. Several alternative embodiments are described below.

According to a first alternative, the means (20) for selecting and the means (30) for activating and deactivating the main antenna correspond to a switch receiving at input a signal received by the first additional antenna and a signal received by the second additional antenna and a signal received by the main antenna and delivering at output one of the signals received by the first additional antenna, the second additional antenna or the main antenna, and the comparison means are implemented in at least one contactless chip (10) receiving at input one of the signals received by the first additional antenna, the second additional antenna or the main antenna, i.e. one of the signals delivered by the switch.

Thus, the solution is implemented via a switch used to switch from one antenna to the other, and thus to first analyse the signal received on the additional antennas before processing the signal received by the main antenna if a contactless payment is detected. This implementation is simple and inexpensive, since only one contactless chip is required to analyse the signals received respectively by the additional antennas and the main antenna.

According to a second alternative, the electronic payment terminal further comprises a second contactless chip (14) associated with the first and second additional antennas and the means (20) for selecting and the means (30) for activating and deactivating the main antenna correspond to a switch receiving at input a signal received by the first additional antenna and a signal received by the second additional antenna and delivering at output one of the signals received by the first additional antenna or the second additional antenna, and the comparison means (40) are implemented in the processor (CPU).

Thus, as for the second alternative of the first embodiment, the solution is implemented via a second contactless chip dedicated to the additional antennas and the CPU of the electronic payment terminal implements the switch between processing the signal received respectively by one of the additional antennas and the signal received by the main antenna.

According to a third alternative, the electronic payment terminal further comprises a second contactless chip (11) associated with the first additional antenna and a third contactless chip (12) associated with the second additional antenna and the means (20) for selecting and the means (30) for activating and deactivating the main antenna (AP) are implemented in the processor (CPU).

According to this third alternative, a contactless chip is dedicated to each of the additional antennas and the CPU of the electronic payment terminal implements the switch between processing the signal received respectively by one of the additional antennas and the signal received by the main antenna.

This technique also relates to a method for detecting an electronic payment mode via an electronic payment card and an electronic payment terminal, comprising at least one contactless payment antenna, referred to as the main antenna, and a first additional antenna, said antennas being capable of receiving a signal transmitted by the electronic payment card, the method comprising the following steps implemented in the electronic payment terminal:
a step (E10) of deactivating the main antenna;
a step (E11) of selecting the first additional antenna;
a first step (E12) of comparing a level of signal received from the electronic payment card by the first additional antenna with a first predetermined threshold delivering a first comparison result and, if the first comparison result is positive, a step (E13) of activating the main antenna in order to implement a contactless transaction between the electronic payment terminal and the electronic payment card.

Such a method is implemented in particular in an electronic payment terminal according to the various embodiments described previously and can be used to determine the payment mode chosen by the user depending on the approach of their payment card.

According to a special aspect, the method further comprises a step of deactivating the first additional antenna, when a contactless payment mode is detected. This step is implemented in particular when a switch is used to switch between the various antennas.

According to a special characteristic according to which the electronic payment terminal further comprises a second additional antenna capable of receiving a signal transmitted by the electronic payment card, the method further comprises a second step of comparing a level of signal received from the electronic payment card by the second additional antenna with a second predetermined threshold delivering a second comparison result, and the step of activating the main antenna in order to implement a contactless transaction between the electronic payment terminal and the electronic payment card is triggered if the second comparison result is positive.

According to a special aspect, the method further comprises a step of deactivating the second additional antenna, when a contactless payment mode is detected. This step is implemented in particular when a switch is used to switch between the various antennas.

According to a preferred implementation, the various steps of the methods according to the invention are implemented by one or more computer software packages or programs, comprising software instructions to be executed by a data processor of an electronic payment terminal according to this technique, and being designed to control the execution of the various steps of the method, implemented in the electronic payment terminal.

The invention therefore also relates to programs, likely to be executed by a computer or a data processor, these programs comprising instructions to control execution of the steps of the method as mentioned above. A program can use any programming language and may take the form of a source code, an object code, or an intermediate code between source code and object code, as in a partially compiled form, or in any other desirable form.

This technique also relates to an information medium that can be read by a data processor and comprising instructions of a program as mentioned above. The information medium can be any entity or device capable of storing the program. For example, the medium can comprise a storage means, such as a ROM, for example a CD ROM or a microelectronic circuit ROM, or a magnetic recording means, for example a mobile medium (memory card) or a hard disk or an SSD. In addition, the information medium can be a transmissible medium such as an electrical or optical signal, that can be routed via an electrical or optical cable, by radio or by other means. The program according to the invention can be downloaded in particular on an Internet type network. Alternatively, the information medium can be an integrated circuit incorporating the program, the circuit being adapted to execute or to be used in the execution of the method concerned.

According to one embodiment, this technique is implemented using software and/or hardware components. In this context, the term “module” can correspond in this document to a software component, a hardware component or a set of hardware and software components.

A software component corresponds to one or more computer programs, one or more sub-programs of a program, or more generally to any element of a program or software package adapted to implement a function or a set of functions, as described below for the module concerned. Such a software component is executed by a data processor of a physical entity (terminal, server, gateway, set-top-box, router, etc.) and may need to access the hardware resources of this physical entity (memories, recording media, communication buses, input/output electronic boards, user interfaces, etc.). Similarly, a hardware component corresponds to any element of a hardware set adapted to implement a function or a set of functions, as described below for the module concerned. It may consist of a hardware component that is programmable or has a built-in processor to execute software, for example an integrated circuit, a smart card, a memory card, an electronic card to execute firmware, etc. Obviously, each component of the system described above implements its own software modules.

The various above-mentioned embodiments can be combined together to implement the invention.

### BRIEF DESCRIPTION OF THE DRAWINGS

Other purposes, characteristics and advantages of the invention will appear more clearly on reading the description which follows given as a simple illustrative and non-limiting example, and referring to the attached drawings, in which:

FIG. 1a shows a perspective view of a part of an electronic payment terminal, according to the prior art;

FIG. 1b shows a front view of a part of an electronic payment terminal, according to the prior art;

FIG. 2a shows a front view of a part of an electronic payment terminal, according to a first embodiment of the invention;

FIG. 2b shows an example of a diagram for implementing a first alternative of the first embodiment as shown on figure FIG. 2a;

FIG. 2c shows an example of a diagram for implementing a second alternative of the first embodiment as shown on figure FIG. 2a;

FIG. 3a shows a front view of an electronic payment card reader, according to a second embodiment of the invention;

FIG. 3b shows an example of a diagram for implementing a first alternative of the second embodiment as shown on figure FIG. 3a;

FIG. 3c shows an example of a diagram for implementing a second alternative of the second embodiment as shown on figure FIG. 3a;

FIG. 3d shows an example of a diagram for implementing a third alternative of the second embodiment as shown on figure FIG. 3a; and

FIG. 4 shows the main steps of a method for detecting an electronic payment mode, according to one embodiment.

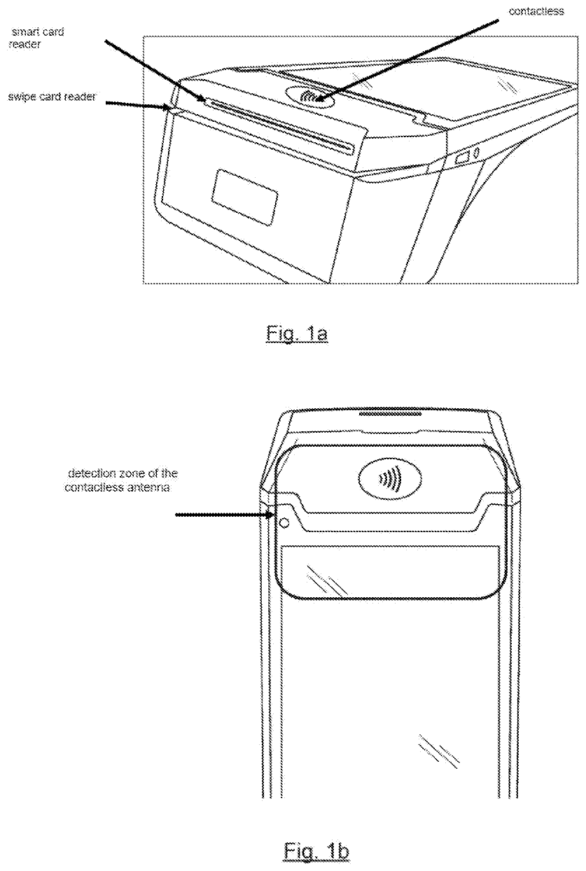

### DETAILED DESCRIPTION OF THE EMBODIMENTS OF THE INVENTION

The main principle of the invention consists in implementing at least one additional antenna for detecting the approach of a payment card, in order to determine at an early stage the payment mode chosen by the user (contactless payment, payment by reading a smart card inserted in a dedicated card reader or payment by reading a swipe card sliding in a dedicated card reader) depending on the card approach area detected.

To do this, the additional antenna(s), positioned strategically in the electronic payment terminal with respect to the main contactless payment antenna and to the card approach areas depending on the payment modes, measure(s) levels of signal received from the card when approaching the electronic payment terminal. Detection of the payment mode is then based on these measurements of levels of signal received or calculations of differential levels of signal received by different antennas.

In addition, the technical solution is based on processing the signals received from the additional antenna(s) without processing the signal received by the main contactless payment antenna, to avoid initiating the contactless payment procedure before having determined that the user actually wants to make a contactless payment. Thus, in this way, the electronic payment terminal does not initiate communication between the approaching payment card and the main antenna until it has determined that the user actually wants to make a contactless payment.

This is therefore possible by using the additional antennas and by selecting the signals received from these various antennas, while respecting the standard and the delays required for a contactless payment, since the time to process the signals received by the additional antenna(s) before switching to processing of the signals received by the main contactless payment antenna is short enough to be able to then initiate the contactless payment within the delays required by the standard.

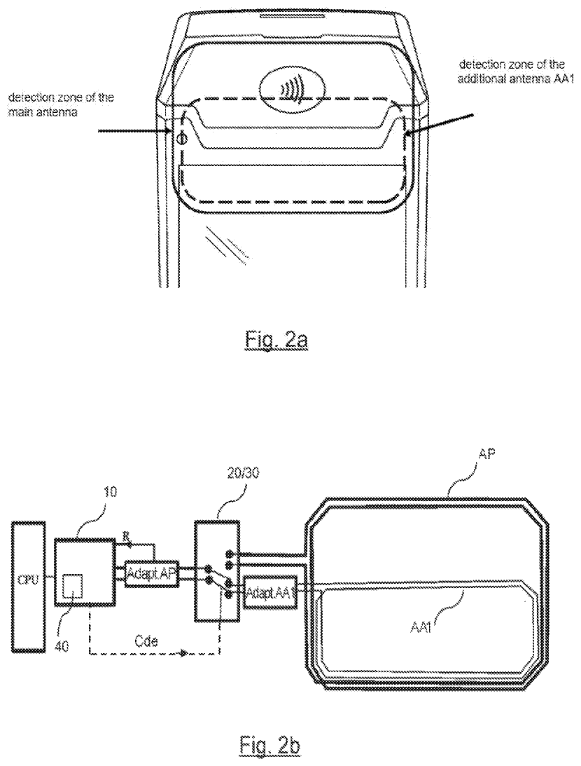

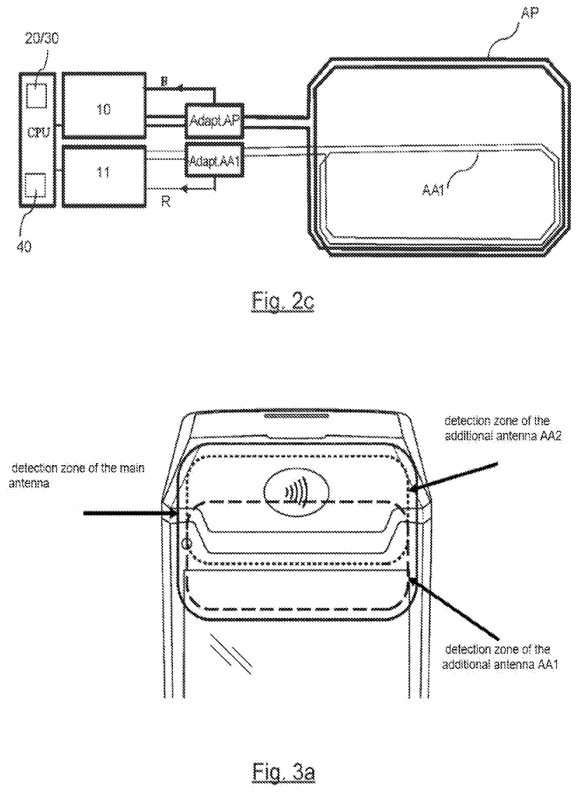

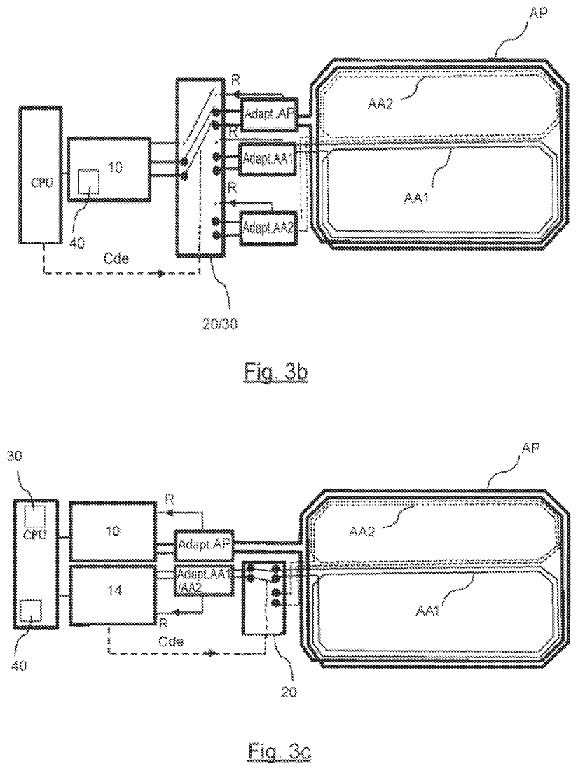

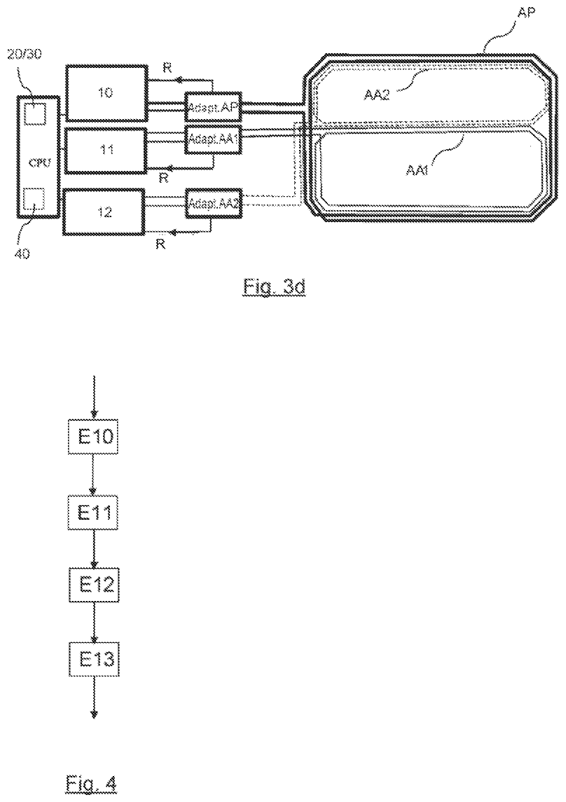

We will now describe the various embodiments and their alternatives, referring to figures FIG. 2a to FIG. 3d, as well as the main steps of the method for detecting an electronic payment mode referring to figure FIG. 4.

Figures FIG. 2a to FIG. 2c show a first embodiment, in which the electronic payment terminal comprises an additional detection antenna AA1, positioned so that its detection area (shown in black dashes) is inside the detection area of the main contactless antenna AP (shown in continuous black lines) as shown on figure FIG. 2a. This position ensures that, if the level of the signals received by this first additional antenna AA1 exceeds a first predetermined threshold, then the user's payment card is in fact approaching for a contactless payment. If in fact the card was approaching for one of the other two payment modes by smart card or swipe card readers, the signals would not be strong enough to be detected by the first additional antenna AA1. Consequently, the antenna must firstly be advantageously positioned in the electronic payment terminal, and with respect to the main antenna AP, and secondly be advantageously configured to be capable of receiving the signals from an approaching smart card.

Thus, as shown in particular on figures FIG. 2b and FIG. 2c, this first additional antenna AA1 is smaller than the main antenna AP and has a smaller field, with no obligation or need to respect the EMV requirements. This first additional antenna AA1 is in fact not intended to implement a contactless payment function, but is used only to determine the payment mode chosen by the user, i.e. to detect a sufficient level of signal from a payment card approaching the electronic payment terminal.

Two implementation alternatives will now be described for this embodiment with one additional antenna, in particular as regards the technical implementation for selecting the signals received from the main antenna and the additional antenna. The first alternative, shown on figure FIG. 2b, consists in implementing a two-way analogue switch 20 to select which antenna, either the first additional antenna 1 or the main antenna AP, is used. Such a switch is a known electronic component which will not be described in more detail in this patent application. Thus, not only can the switch 20 be used to select the signals received from the main antenna AAP or the first additional antenna AA1, before they are processed by the existing contactless chip 10 (which traditionally handles the processing of the signal from the main antenna AP), but the switch 20 can also be used to disable/deactivate the main antenna AP which then cannot communicate with a payment card approaching the electronic payment terminal. The switch 20 therefore also acts as means 30 for deactivating the main antenna AP.

Thus, according to this first alternative, the analogue switch 20 selects, when the electronic payment terminal is started, the first additional antenna 1. Thus, the latter creates a magnetic field that is strong enough to activate an electronic payment card approaching the electronic payment terminal and receive a signal from this electronic payment card. Then, the level of the signal received (marked R on the figures) by the first additional antenna 1 is compared, periodically for example, with a predetermined threshold S1. This comparison is implemented by comparison means 40 implemented in the contactless chip 10, which then controls the switch 20: if the level of signal received on the first additional antenna 1 corresponds to approaching the card for a contactless payment, the switch 20 switches to reception of the signals received by the main antenna AP for a contactless payment. In this case, the switch 20 also acts as means 30 for activating the main antenna AP and for deactivating the first additional antenna 1.

Otherwise, the contactless function is not activated, and payment by reading the smart card or the swipe card is implemented, depending on whether the user inserts their card in the smart card reader or slides it in the swipe card reader.

Note that, when the first additional antenna 1 is used, it does not communicate with the approaching smart card (in particular since it does not respect the requirements of the EMV standard) but is used only to detect the payment mode. It is therefore possible to temporarily deactivate the main antenna AP, which is the only antenna capable of implementing a contactless payment by communicating with an electronic payment card. In particular, this is possible due to the fact that, in compliance with the EMV standard, the transaction speed requirements must be respected from the moment of the response to detection of the card, this moment not being impacted by the implementation of this technique.

Adjustments must nevertheless be made, both to the antenna operating parameters and the detection threshold S1, in order to optimise activation of the main antenna so that it can detect the approaching card and implement the contactless payment in compliance with the requirements of the EMV standard. These adjustments therefore depend on the characteristics of the antennas used, as well as the requirements of the EMV standard currently in force, and can be implemented when finalising the architecture of the electronic payment terminal, in preparation for the tests required to obtain certification to the standard. This type of adjustment/configuration is known.

These considerations apply to the second alternative of this first embodiment, described below, as well as to the various alternatives of the second embodiment.

This first alternative therefore implements a single contactless chip 10, which represents an advantage in terms of the costs of implementing this technique. This known contactless chip 10 formats in particular all the analogue output signals, for the antennas (at a frequency of 13.56 MegaHerz in particular for contactless payment) and controls the analogue switch 20. Such a contactless chip also decodes the analogue signals and converts them into digital signals.

Furthermore, also in a known manner, antenna adaptation modules Adapt.AP and Adapt.AA1 are implemented to improve the radiation of the antennas, respectively between the switch 20 and the contactless chip 10 for adaptation to the main antenna and between the switch 20 and the first additional antenna 1 for adaptation to the latter. These adaptation modules comprise, for example, capacitors and chokes, in a known manner which will not be described in detail here.

Lastly, the processor CPU corresponds to the processor of the electronic payment terminal and is used in particular to complete a transaction, regardless of the chosen payment mode. Such a processor is therefore not described in detail in this patent application.

In the second alternative, shown on figure FIG. 2c, it is precisely this processor CPU which includes the means 20 for selecting and the means 30 for activating and deactivating the main antenna. Consequently, this second alternative does not implement an analogue switch but requires two contactless chips 10 and 11, connected respectively to the main antenna AP and to the first additional antenna AA1. This second alternative therefore uses a processing and transmission chain (comprising in particular an adaptation module and a contactless chip) dedicated to each antenna. According to this second alternative, the processor CPU controls, when the electronic payment terminal is started, the operation of the first additional antenna 1, so that the latter can create a magnetic field that is strong enough to activate an electronic payment card approaching the electronic payment terminal and receive a signal from this electronic payment card. To do this, the processor CPU selects, via the selection means 20 (for example one or more dedicated electronic components, controlled by one or more programs), the chain dedicated to the first additional antenna AA1 (comprising in particular the antenna adaptation module Adapt.AA1 and the contactless chip 11). At the same time, the chain dedicated to the main antenna AP, i.e. the antenna adaptation module Adapt.AP and the contactless chip 10, are deactivated by the deactivation means 30.

Then, the level of signal received (marked R on the figures) by the first additional antenna 1 is compared, periodically for example, with a predetermined threshold S1. This comparison is implemented by comparison means 40 implemented in the processor CPU. After this comparison, if the level of signal received on the first additional antenna 1 corresponds to approaching the card for a contactless payment, the processor CPU switches to reception of the signals received by the main antenna AP for a contactless payment. In this case, the processor CPU also acts as means for activating the main antenna AP (for example one or more dedicated electronic components, controlled by one or more programs) and for deactivating (for example one or more dedicated electronic components, controlled by one or more programs) the first additional antenna, by disabling the chain dedicated to it.

Otherwise, the contactless function is not activated, and payment by reading the smart card or the swipe card is implemented, depending on whether the user inserts their card in the smart card reader or slides it in the swipe card reader.

By adding an additional detection antenna, it is therefore possible to determine the payment mode based on detection of the approach of the user's smart card, without the contactless function being triggered if the contactless mode is not chosen by the user.

Figures FIG. 3a to FIG. 3d show a second embodiment, in which the electronic payment terminal comprises a first additional detection antenna AA1, positioned so that its detection area (shown in black dashes) is inside the detection area of the main contactless antenna AP (shown in continuous black lines), and a second additional detection antenna AA2, positioned so that its detection area (shown in black dots) is also inside the detection area of the main contactless antenna AP, as shown on figure FIG. 3a.

This position allows the first additional antenna AA1 to be used to detect the contactless payment mode, since it is positioned to detect an approach of the card from above, and the second additional detection antenna AA2 to be used to confirm a payment mode by reading the chip or the magnetic stripe. The principle of this second embodiment consists in fact in comparing, between each other or with respect to predetermined thresholds, the levels of the signals received respectively on the two additional antennas in order to detect the approach area in which the payment card is located.

Consequently, the additional antennas must firstly be advantageously positioned in the electronic payment terminal, and with respect to the main antenna AP, and secondly be advantageously configured to be capable of receiving the signals from an approaching smart card.

Thus, as shown in particular on figures FIG. 3b to FIG. 3d, the additional antennas are smaller than the main antenna AP and have a smaller field, with no obligation or need to respect the EMV requirements. These additional antennas are in fact not intended to implement a contactless payment function, but are used only to determine the payment mode chosen by the user, i.e. to detect a sufficient level of signal from a payment card approaching the electronic payment terminal.

Three implementation alternatives will now be described for this second embodiment with two additional antennas, in particular as regards the technical implementation for selecting the signals received from the main contactless antenna and the additional antennas.

The first alternative, shown on figure FIG. 3b, consists in implementing a three-way analogue switch 20 to select one antenna from the two additional antennas AA1 and AA2 and the main antenna AP.

The operation of this first alternative is similar to that of the first alternative of the first embodiment, described previously, the switch 20 being used to select the signals received from the main antenna AAP, the first additional antenna AA1 or the second additional antenna AA2, before they are processed by the existing contactless chip (which traditionally handles the processing of the signal from the main antenna AP).

The switch 20 also acts as the means 30 for deactivating the main antenna AP, which then cannot communicate with a payment card approaching the electronic payment terminal and for deactivating one of the two additional antennas not selected, and also acts as means 30 for activating the main antenna AP, and for deactivating the additional antennas when the contactless payment mode is detected.

This figure FIG. 3b shows an example of layout of the additional antennas AA1 and AA2 inside the main antenna AP, as well as the corresponding adaptation modules (already described in relation to the first embodiment).

According to this first alternative, the switch 20 can therefore be used to switch from one antenna to the other, depending on the result of comparing the level of signal received on the selected antenna with respect to a threshold. Thus, when the electronic payment terminal is started, the switch 20 is configured to select one of the two additional antennas AA1 or AA2, for example the antenna AA2 (the most capable of detecting an approach for a contact payment). The signal received on this antenna is then processed by the contactless chip 10, which compares the level of this signal received with a predetermined threshold S2. This comparison can, for example, be carried out periodically, for a given duration, by comparison means 40. After this duration or when the threshold is exceeded, the contactless chip 10 then instructs the switch 20 to switch to the first additional antenna AA1, in order to confirm or deny the payment mode detected via the second additional antenna AA2.

Thus, if the level of signal received on this antenna exceeds the threshold S2, a contact payment mode is detected and it is confirmed if the level of signal received by the first additional antenna AA1 is less than a predetermined threshold S1, this comparison also being implemented by the comparison means 40 implemented in the contactless chip 10. In fact, if the antenna that is the most capable of detecting a contactless payment mode (the first additional antenna AA1 according to this embodiment) receives no signal or a very low signal when a card approaches the electronic payment terminal, this means that the card is approaching for a payment via one of the two card readers (smart card or swipe card). On the contrary, if the two additional antennas receive a sufficiently strong signal (i.e. respectively above thresholds S1 and S2), this indicates that the card is approaching from above, for a contactless payment mode.

It is also possible to first select the first additional antenna then the second, according to the same principle.

Note that a differential measurement of the levels of signal received by the two additional antennas can be performed to improve the position and approach of the user's card, for example when the signals received are too close to the predetermined threshold received for the comparisons. For example, if a payment mode by reader is detected (due to the level of signal received on the additional antenna AA2 and to the weakness or absence of signal received by the first additional antenna AA1), the signals received respectively by these two antennas can be compared to ensure that the difference in level is significant and that a contactless approach is not considered. On the contrary, if the levels of the two signals received by the two additional antennas are very close, even less than a threshold for one or the other, it is likely that an approach for a contactless payment must be detected.

The second alternative, shown on figure FIG. 3c, also consists in implementing a two-way analogue switch 20 to select one of the two additional antennas AA1 and AA2. These 2 additional antennas are therefore wired to the same reception chain, with a specific contactless chip 14, the switch 20 allowing the two additional antennas AA1 and AA2 (which are also associated respectively with an adaptation module, as already described above) to be used sequentially.

In addition, as for the second alternative of the first embodiment, a chain dedicated to the main antenna AP is implemented, with a dedicated contactless chip 10.

As for the first alternative of this second embodiment, when the electronic payment terminal is started, the switch 20 is configured to select one of the two additional antennas AA1 or AA2, for example the antenna AA2 (the most capable of detecting an approach for a contact payment). On the contrary, the processor CPU implements the means 30 for activating and deactivating the main antenna (for example one or more dedicated electronic components, controlled by one or more programs).

As for the first alternative, the switch can be used to switch to one of the two additional antennas AA1 and AA2, for example by first detecting a contact payment mode, via the second additional antenna AA2, then the level of signal from the first antenna is analysed. If it is greater than the threshold S1, then the contactless payment mode is detected, otherwise, another payment mode is detected. The means 30 for activating the main antenna AP are then triggered as well as the means for deactivating the two additional antennas.

The third alternative, shown on figure FIG. 3d, does not implement a switch, but implements three dedicated reception chains to which the two additional antennas and the main antenna are respectively wired.

Three contactless chips 10, 11 and 12 are respectively associated with the main antenna AP, the first additional antenna AA1 and the second additional antenna AA2. The processor CPU therefore implements the means 20 (for example one or more dedicated electronic components, controlled by one or more programs) for selecting one of the two additional antennas, only for detection purposes since no communication is initiated between the card and its antennas, as already indicated above. Thus, the level of the signal received on these additional antennas is analysed and compared with predetermined thresholds: if only one antenna detects signal, then the mode by card reader (smart card or swipe card) is detected, whereas if the two additional antennas detect signal, contactless mode is detected.

The processor CPU then sends a command to switch to the main antenna and to deactivate the additional antennas. The processor CPU also sends a command to deactivate the main antenna at start-up.

The principle of this second embodiment can be reproduced with more than 2 additional antennas to make detection of a payment mode even more precise and efficient.

We will now describe, referring to figure FIG. 4, the main steps of the method for detecting a payment mode via an electronic payment card and an electronic payment terminal as described above according to the various embodiments, with one or two additional detection antennas.

When the electronic payment terminal is started, a step E10 of deactivating the main antenna is implemented, so that the contactless payment function is not triggered as soon as a signal from a card approaching the electronic payment terminal is detected. A step E11 of selecting the first additional antenna is therefore also implemented, in order to process the signal received via this antenna.

A first step E12 of comparing a level of signal received from the electronic payment card by the first additional antenna with a first predetermined threshold is then implemented, periodically and/or for a predetermined duration. If, after this duration, a first negative comparison result is delivered, then a contact payment mode is detected and the main antenna is not reactivated.

On the contrary, when the level of signal is greater than the threshold, a first positive comparison result is delivered and a step E13 of activating the main antenna is implemented to initiate a contactless transaction between the electronic payment terminal and the electronic payment card.

Obviously, this method of detecting a payment mode is adapted to all the technical embodiments of the electronic payment terminal and of the additional antennas described above, with the implementation of additional steps of selecting a second additional antenna and of making a second comparison of the level of the signal received by this antenna in particular.

Thus, the solution described above, according to the various embodiments, can be used to detect the payment mode chosen by the user when approaching their payment card and without triggering the contactless payment function when this is not required (i.e. when the user inserts their card in the smart card reader or slides it in the swipe card reader).

1. An electronic payment terminal comprising a processor (CPU), characterised in that it further comprises at least one contactless payment antenna, referred to as a main antenna (AP), and a first additional antenna (AA1), said antennas being capable of receiving a signal transmitted by an electronic payment card, and in that it comprises:
means for activating and deactivating said main antenna (AP);
means for selecting said first additional antenna (AA1); and
means for comparing, with a first predetermined threshold (S1), a level of signal received from said electronic payment card by said first additional antenna (AA1), said comparison means delivering a first comparison result and triggering, if said first comparison result is positive, said means for activating said main antenna (AP) in order to implement a contactless transaction between said electronic payment terminal and said electronic payment card.

2. The electronic payment terminal according to claim 1, characterised in that said means for selecting and said means for activating and deactivating said main antenna correspond to a switch receiving at input a signal received by said first additional antenna and a signal received by said main antenna and delivering at output one of said signals received by said first additional antenna and by said main antenna, and in that said comparison means are implemented in at least one contactless chip receiving at input one of said signals received by said first additional antenna and by said main antenna.

3. The electronic payment terminal according to claim 1, characterised in that it further comprises a second contactless chip associated with said first additional antenna and in that said means for selecting and said means for activating and deactivating said main antenna (AP) are implemented in said processor (CPU).

4. The electronic payment terminal according to claim 1, characterised in that it further comprises a second additional antenna (AA2) capable of receiving a signal transmitted by said electronic payment card, and in that said selection means select the second additional antenna and said comparison means compare a level of signal received from said electronic payment card by said second additional antenna (AA2) with a second predetermined threshold delivering a second comparison result and triggering, if said second comparison result is positive, said means for activating said main antenna (AP) in order to implement a contactless transaction between said electronic payment terminal and said electronic payment card.

5. The electronic payment terminal according to claim 4, characterised in that said means for selecting and said means for activating and deactivating said main antenna correspond to a switch receiving at input a signal received by said first additional antenna and a signal received by said second additional antenna and a signal received by said main antenna and delivering at output one of said signals received by said first additional antenna, said second additional antenna or said main antenna, and in that said comparison means are implemented in at least one contactless chip receiving at input one of said signals received by said first additional antenna, said second additional antenna or said main antenna.

6. The electronic payment terminal according to claim 4, characterised in that it further comprises a second contactless chip associated with said first and said second additional antennas and in that said means for selecting and said means for activating and deactivating said main antenna correspond to a switch receiving at input a signal received by said first additional antenna and a signal received by said second additional antenna and delivering at output one of said signals received by said first additional antenna or said second additional antenna, and in that said comparison means are implemented in said processor (CPU).

7. The electronic payment terminal according to claim 4, characterised in that it further comprises a second contactless chip associated with said first additional antenna and a third contactless chip associated with said second additional antenna and in that said means for selecting and said means for activating and deactivating said main antenna (AP) are implemented in said processor (CPU).

8. A method for detecting an electronic payment mode via an electronic payment card and an electronic payment terminal, characterised in that said electronic payment terminal comprises at least one contactless payment antenna, referred to as a main antenna, and a first additional antenna, said antennas being capable of receiving a signal transmitted by said electronic payment card, and in that said method comprises steps implemented in said electronic payment terminal of:
a step of deactivating said main antenna;
a step of selecting said first additional antenna;
a first step of comparing a level of signal received from said electronic payment card by said first additional antenna with a first predetermined threshold delivering a first comparison result and, if said first comparison result is positive, a step of activating said main antenna in order to implement a contactless transaction between said electronic payment terminal and said electronic payment card.

9. The method according to claim 8, characterised in that it further comprises a step of deactivating said first additional antenna.

10. The method according to claim 9, characterised in that said electronic payment terminal further comprises a second additional antenna capable of receiving a signal transmitted by said electronic payment card and in that said method further comprises a second step of comparing a level of signal received from said electronic payment card by said second additional antenna with a second predetermined threshold delivering a second comparison result,
and in that said step of activating said main antenna in order to implement a contactless transaction between said electronic payment terminal and said electronic payment card is triggered if said second comparison result is positive.

11. The method according to claim 10, characterised in that it further comprises a step of deactivating said second additional antenna.

12. The method according to claim 8, characterised in that said electronic payment terminal further comprises a second additional antenna capable of receiving a signal transmitted by said electronic payment card and in that said method further comprises a second step of comparing a level of signal received from said electronic payment card by said second additional antenna with a second predetermined threshold delivering a second comparison result,
and in that said step of activating said main antenna in order to implement a contactless transaction between said electronic payment terminal and said electronic payment card is triggered if said second comparison result is positive.
